(19) United States
(12) Patent Application Publication
(10) Pub. No.: US 2008/0205515 A1
(43) Pub. Date: Aug. 28, 2008

(54) Video encoding with reduced complexity

(75) Inventors: Hari Kalva, Delray Beach, FL (US); Gerardo Fernandez Escribano, Albacete (ES)

Correspondence Address: MARTIN NOVACK, 16355 VINTAGE OAKS LANE, DELRAY BEACH, FL, 33484, US

(73) Assignee: Florida Atlantic University

(21) Appl. No.: 12/011,469

(22) Filed: Jan. 25, 2008

Related U.S. Application Data
(60) Provisional application No. 60/897,353, filed on Jan. 25, 2007.

(51) Int. Cl. H04N 7/26

(52) U.S. Cl. 375/240.02; 375/E07.126

(57) ABSTRACT

A method for encoding frames of input video signals, including the following steps: implementing a learning/configuring stage that includes the following steps: providing frames of training video signals; determining training statistical parameters for groups of pixels of the frames of training video signals, and also encoding the frames of training video signals to obtain training modes; configuring a decision tree in response to the training statistical parameters and the training modes; and implementing an operating/encoding stage that includes the following steps: determining operating statistical parameters for groups of pixels of the frames of input video signals, and applying the operating statistical parameters to the configured decision tree to obtain operating modes; and encoding the frames of input video signals using the frames of input video signals and the operating modes.

### RELATED APPLICATION

Priority is claimed from U.S. Provisional Patent Application Number 60/897,353, filed Jan. 25, 2007, and said U.S. Provisional Patent Application is incorporated by reference. Subject matter of the present Application is generally related to subject matter in copending U.S. patent application Ser. No. ______, filed of even date herewith, and assigned to the same assignee as the present Application.

### FIELD OF THE INVENTION

This invention relates to compression of video signals and, more particularly, to compressing frames of video signals, for example in accordance with a video encoding standard, such as H.264, with reduced complexity.

### BACKGROUND OF THE INVENTION

The H.264 video coding standard (also known as Advanced Video Coding or AVC) was developed, a few years ago, through the work of the International Telecommunication Union (ITU) video coding experts group and MPEG (see ISO/IEC JTC11/SC29/WG11, “Information Technology—Coding of Audio-Visual Objects—Part 10; Advanced Video Coding”, ISO/IEC 14496-10:2005, incorporated by reference). A goal of the H.264 project was to create a standard capable of providing good video quality at substantially lower bit rates than previous standards (e.g. half or less the bit rate of MPEG-2, H.263, or MPEG-4 Part 2), without increasing the complexity of design so much that it would be impractical or excessively expensive to implement. An additional goal was to provide enough flexibility to allow the standard to be applied to a wide variety of applications on a wide variety of networks and systems. The H.264 standard is flexible and offers a number of tools to support a range of applications with very low as well as very high bitrate requirements. New generation codecs, such as H.264 and VC1 are highly efficient and result in equivalent quality video at ⅓ to ½ of MPEG-2 video bitrates. The complexity of this new encoder, however, is 10 times as complex as MPEG-2. The compression efficiency has a high computational cost associated with it. The high computational cost is the key reason why these increased compression efficiencies cannot be exploited across all application domains. Low complexity devices such as cell phones, embedded cameras, and video sensor networks use simpler encoders or simpler profiles of new codecs to tradeoff compression efficiency and quality for reduced complexity. The new video codecs from large manufactures are using hybrid coding techniques similar to H.264 and are comparable in complexity and quality. The complexity of the next generation codecs is expected to increase exponentially.

The compression efficiency of these new codecs has increased mainly because of the large number of coding options available. For example, the H.264 video supports Intra prediction with 3 different block sizes and Inter prediction with 8 different block sizes. The encoding of a macroblock involves evaluating all the possible block sizes. As the number of reference frames are increased, the complexity increases proportionally. Reducing the encoding complexity is primarily done using fast algorithms for motion estimation and MB mode selection. Work on fast motion estimation and MB mode selection has been reported but the gains are still limited.

It is among the objects of the present invention to substantially reduce the encoding complexity without unduly sacrificing quality.

### SUMMARY OF THE INVENTION

One of the concepts underlying the invention is the hypothesis that video frames can be characterized for the purpose of encoding and this can be exploited to greatly reduce encoding complexity. This invention has applications in encoding video where available computing resources (CPU, power) are a key constraint. Applications include, without limitation, mobile phones, video sensor networks, embedded systems, video surveillance, security cameras etc.

Video is typically encoded one frame at a time. The compression is achieved primarily by removing spatial, temporal, and statistical redundancies. Temporal redundancies, or similarities between successive frames, contribute the most toward compression. Each frame of video is divided into blocks (typical 16×16 pixels and referred to as macroblocks) and prediction is performed at the block level. The efficiency of encoding can be improved by allowing the blocks to be partitioned into sub-blocks for prediction. As the number of partitions increases, the complexity of encoders increases as the encoders have to now evaluate each block size before determining the best coding mode. For example, the H.264 standard allows a 16×16 block to be partitioned into two 16×16, or two 8×16 or four 8×8 blocks; each 8×8 block can in turn be partitioned into two 8×4 or two 4×8 or four 4×4 blocks for temporal prediction. For spatial prediction, H.264 allows three options: 16×16, 8×8 and 4×4 block sizes.

Machine learning has been widely used in image and video processing for applications such as content based image and video retrieval (CBIR), content understanding, and more recently video mining. Video encoding was not considered complex enough to use machine learning approaches. Furthermore, classifying macroblocks (MB) in natural images and video is extremely difficult given the large problem space. The complexity of H.264 video encoding the expected increase in complexity in next generation video encoding such as H.265 is motivation to consider new approaches. An approach of an embodiment hereof is based on using simple mean and variance operations and classifying the MBs based on the relative metrics; for example, how close are the mean values of the neighboring pixel blocks. These seemingly simple metrics give very good performance in determining MB mode and prediction mode of MBs. In an embodiment hereof, a hierarchy of decision trees is developed based on the relative mean metrics to compute Intra MB modes quickly.

In an embodiment hereof, the Weka data mining tool is used in training and evaluating the decision trees, and the widely studied and used C4.5 algorithm. The C4.5 learning algorithm is considered a generic learning algorithm with broad applicability. The Java implementation of this algorithm in Weka is referred to as J4.8. The Weka tool input is an attribute relation file format (ARFF). The file contains the attributes (e.g., mean of 4×4 sub blocks) that are used to classify a target class (e.g, Intra MB mode). The output of Weka is a decision tree built with the J4.8 algorithm

In a form of the invention, a method is set forth for encoding frames of input video signals, including the following steps: implementing a learning/configuring stage that includes the following steps: providing frames of training video signals; determining training statistical parameters for groups of pixels of said frames of training video signals, and also encoding said frames of training video signals to obtain training modes; configuring a decision tree in response to said training statistical parameters and said training modes; and implementing an operating/encoding stage that includes the following steps: determining operating statistical parameters for groups of pixels of said frames of input video signals, and applying said operating statistical parameters to said configured decision tree to obtain operating modes; and encoding said frames of input video signals using said frames of input video signals and said operating modes.

In an embodiment of this form of the invention, the step of configuring a decision tree in response to said training statistical parameters and said training modes comprises performing a machine learning routine to configure said decision tree to implement mode selections as a function of statistical parameters, based on observed correlations between said training statistical parameters and said training modes. In this embodiment, the training modes and operating modes include macroblock modes and predictive modes, and the statistical parameters for groups of pixels of frames of training video signals and input video signals include means of blocks of pixels and variance of said means. In an embodiment of this form of the invention, the statistical parameters for groups of pixels from frames of training video signals and input video signals are derived from blocks of pixels of successive frames. In this embodiment, the training modes and operating modes include macroblock prediction modes and motion vector data. In an embodiment of this form of the invention, the step of encoding said frames of input video signals using said frames of input video signals and said operating modes comprises encoding said frames of input video signals using said operating modes instead of corresponding modes that are not computed from said frames of input video signals.

In a further form of the invention, a method is set forth for encoding a video signal, including the following steps: separating frames of video into a multiplicity of macroblocks; computing, for each macroblock, at least one statistical parameter; selecting, for each of said macroblocks, a sub-block coding criterion based on the computed at least one statistical parameter of the respective macroblock; implementing the selected coding criterion on sub-blocks of each respective macroblock to obtain encoded macroblocks; and producing an encoded video signal using the encoded macroblocks. In an embodiment of this form of the invention, said statistical parameter is indicative of detail in a macroblock, and said step of computing, for each macroblock, at least one statistical parameter, comprises computing, for each macroblock, a variance of values in the macroblock. In this embodiment, said step of computing, for each macroblock, at least one statistical parameter, comprises computing, for each macroblock, a variance of means of pixel values in equal sized groups of pixels in the macroblock.

Further features and advantages of the invention will become more readily apparent from the following detailed description when taken in conjunction with the accompanying drawings.

### BRIEF DESCRIPTION OF THE DRAWINGS

FIG. 1 is a block diagram of a type of system that can be used in practicing embodiments of the invention.

FIG. 2 is a diagram of a routine that can be used for the training/configuring stage, including building a decision tree, for Intra macroblock encoding, in accordance with an embodiment of the invention.

FIG. 3 is a diagram of a routine that can be used for the operating/encoding stage of a process, including using decision trees for speeding up Intra macroblock encoding, in accordance with an embodiment of the invention.

FIG. 4 is a diagram illustration operation of a decision tree for Intra macroblock encoding for an example used in describing an embodiment of the invention.

FIG. 5 is a diagram of a routine that can be used for the training/configuring stage, including building a decision tree for Inter macroblock encoding, in accordance with an embodiment of the invention.

FIG. 6 is a diagram of a routine that can be used for the operating/encoding stage of a process, including using decision trees for speed up Inter macroblock encoding, in accordance with an embodiment of the invention.

### DETAILED DESCRIPTION

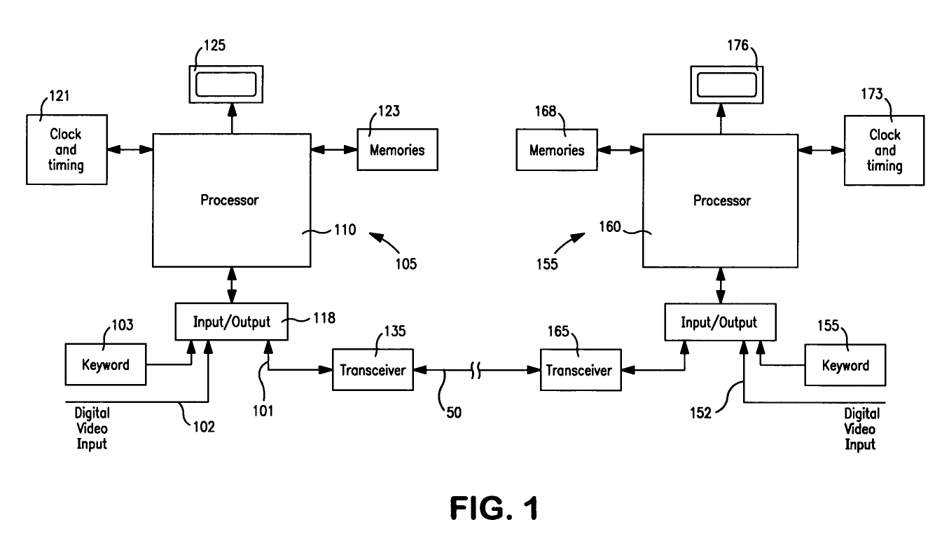

FIG. 1 is a block diagram of a type of system that can be used in practicing embodiments of the invention. Two processor-based subsystems 105 and 155 are shown as being in communication over a channel or network 50, which may be, for example, any wired or wireless communication channel such as an internet communication channel or network. The subsystem 105 includes processor 110 and the subsystem 155 includes processor 160. When programmed in the manner to be described, the processor 110 and its associated circuits can be used to implement embodiments of the invention. Also, it will be understood that plural processors can be used at different times.

The processors 110 and 160 may each be any suitable processor, for example an electronic digital processor or microprocessor. It will be understood that any general purpose or special purpose processor, or other machine or circuitry that can perform the functions described herein, can be utilized. The subsystem 105 will typically include memories 123, clock and timing circuitry 121, input/output functions 118 and monitor 125, which may all be of conventional types. The memories can hold any required programs. Inputs include a keyboard input as represented at 103 and digital video input 102, which may comprise, for example, conventional video or sequences of image-containing frames. Communication is via transceiver 135, which may comprise modems or any suitable devices for communicating signals.

The subsystem 155 in this illustrative embodiment can have a similar configuration to that of subsystem 105. The processor 160 has associated input/output circuitry 164, memories 168, clock and timing circuitry 173, and a monitor 176. Inputs include a keyboard 153 and digital video input 152. Communication of subsystem 155 with the outside world is via transceiver 165 which, again, may comprise modems or any suitable devices for communicating signals. It will be understood that the decoding subsystem, represented in FIG. 1 by the processor subsystem 155 can be in any suitable form as used, for example, in various types of applications including cable and wireless video, cell phone and other hand-held devices, video surveillance, etc.

In embodiments hereof, video signals are encoded, using a method of the invention, to produce signals consistent with an encoding standard, for example H.264 decoding, using the processor subsystem 155, can include, for this example, an H.264 decoding capability.

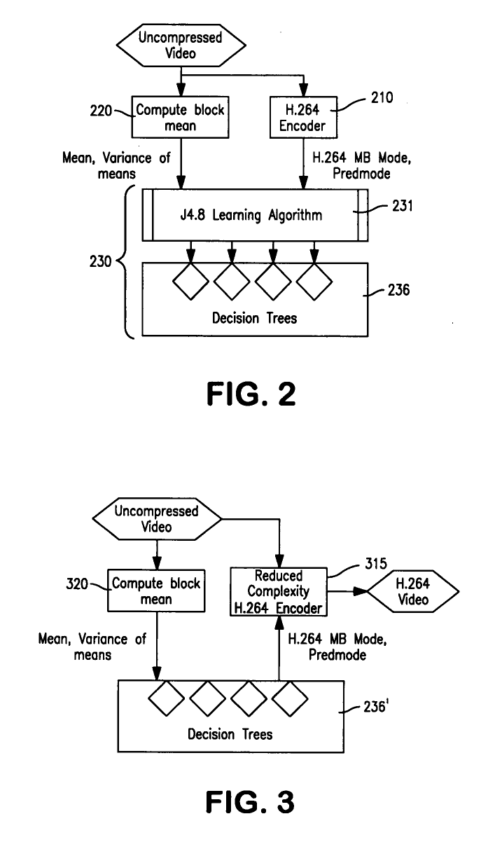

FIGS. 2 and 3 show the high level process for an embodiment of the invention. In the example of this embodiment, the encoding used is H.264. In the example of this embodiment, reduced complexity for intra macroblock (MB) coding is illustrated. FIG. 2 is a diagram of the learning/configuration stage for this embodiment, and FIG. 3 is a diagram of the operating/encoding stage for this embodiment. The uncompressed video is encoded with H.264 (block 210) and at the same time, the means of the 4×4 sub blocks of a 16×16 MB and the variance of the means of the 16 4×4 sub-blocks of the MB are computed. These values, together with the MB mode, for the current MB, as determined by a H.264 encoder, are input to a machine learning routine 230, which can be implemented, in this embodiment by Weka/J4.8. As is known in the machine learning art, a decision tree is made by mapping the observations about a set of data in a tree made of arcs and nodes. The nodes are the variables and the arcs the possible values for that variable. The tree can have more than one level; in that case, the nodes (leafs of the tree) represent the decision based on the values of the different variables that drives us from the root to the leaf. These types of trees are used in the data mining processes for discovering the relationship in a set of data, if it exits. The tree leafs are the classifications and the branches are the features that lead to a specific classification.

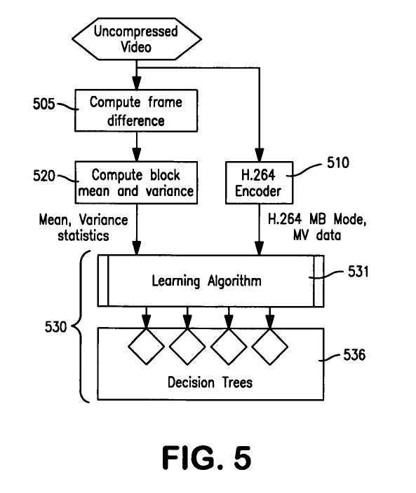

The decision tree of an embodiment hereof is made using the WEKA data mining tool. The files that are used for the WEKA data mining program are known as ARFF (Attribute-Relation File Format) files (see Ian H. Witten and Eibe Frank, “Data Mining: Practical Machine Learning Tools And Techniques”, 2^{nd} Edition, Morgan Kaufmann, San Francisco, 2005). An ARFF file is written in ASCII text and shows the relationship between a set of attributes. Basically, this file has two different sections; the first section is the header with the information about the name of the relation, the attributes that are used and their types; and the second data section contains the data. In the header section is the attribute declaration. Reference can be made to our co-authored publications G. Fernandez-Escribino, H. Kalva, P. Cuenca, and L. Orozco-Barbosa, “RD Optimization For MPEG-2 to H.264 Transcoding,” Proceedings of the IEEE International Conference on Multimedia & Expo (ICME) 2006, pp. 309-312, and G. Fernandez-Escribino, H. Kalva, P. Cuenca, and L. Orozco-Barbosa, “Very Low Complexity MPEG-2 to H.264 Transcoding Using Machine Learning,” Proceedings of the 2006 ACM Multimedia conference, October 2006, pp. 931-940, both of which relate to machine learning used in conjunction with transcoding. It will be understood that other suitable machine learning routines and/or equipment, in software and/or firmware and/or hardware form, could be utilized. The learning routing 230 is shown in FIG. 2 (and also in FIG. 5, described below) as comprising the learning algorithm 231 and decision tree(s) 236. The mode decisions subsequently made using the configured decision trees are used in the encoder instead of the actual mode search code that would conventionally be used in an H.264 encoder.

FIG. 3 shows the use of the configured decision trees 236′ to accelerate video encoding. In FIG. 3, uncompressed frames of video are coupled with a modified encoder 315 which, in this embodiment, is a reduced complexity H.264 encoder. An example of a reduced complexity encoder, in the context of another decoder, is described in copending U.S. patent application Ser. No. 11/999,501, filed Dec. 5, 2007, and assigned to the same assignee as the present Application. The uncompressed video is also coupled with block 320 which operates, in a manner similar to block 220 of FIG. 2, to compute the means of the 4×4 sub-blocks of the current 16×16 MB and the variance of the means of the 16 4×4 sub-blocks of the MB, for this embodiment. These computed statistical values are input to the configured decision tree 236′, which outputs the Intra MB mode and Intra prediction mode, which are then used by encoder 315, which is modified to use these modes instead of the normally derived corresponding modes, thereby saving substantial computation resource. The decision trees are just if-else statements and have negligible computational complexity. Depending on the decision tree, the mean values used are different, as treated subsequently. The set of decision trees used in the H.264 Intra MB coding are used in a hierarchy to arrive at the Intra MB mode and Intra prediction mode quickly. In an example of the present embodiment; the trees are trained using 396 MBs from one Intra frame of a CIF video.

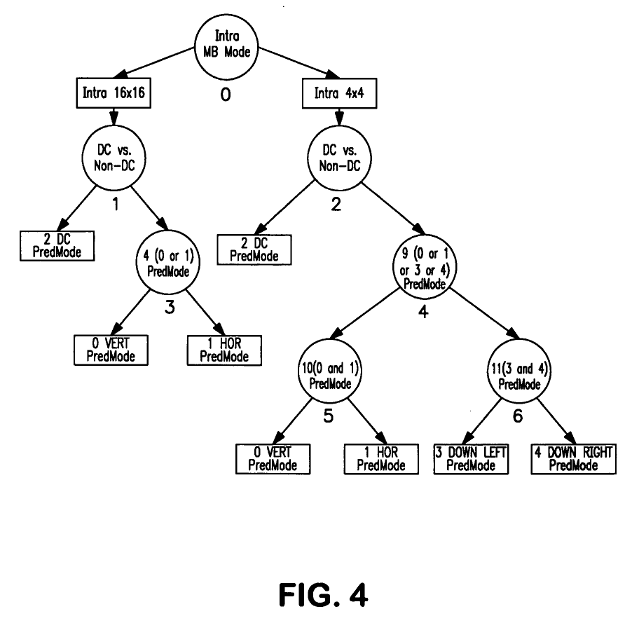

FIG. 4 shows the hierarchical decision tree used in the proposed Intra MB encoder. The nodes of the tree (circles numbered 0 through 6) are the decision points and the leaves of the tree (rectangles) are the final decisions. Each node makes a binary decision and additional nodes down in the hierarchy are used to make further classification, if necessary. As shown in the Figure, the MB modes in this embodiment are classified into Intra 16×16 and Intra 4×4 targeting mobile applications. Intra 8×8 mode is not considered in this example. The prediction mode decisions in this embodiment do not support mode 3 in Intra 16×16 and modes 5, 6, 7, and 8 in Intra 4×4. Reducing the prediction modes is desirable to simplify the decision tree. This use of the reduced set of prediction modes is expected to have negligible impact on the PSNR. The hierarchical decision tree of this embodiment uses 7 binary decisions; a maximum of 3 decisions are necessary for Intra 16×16 and 4 are necessary for Intra 4×4.

### Intra MB Mode Decision (Node 0)

An Intra MB is coded as Intra 16×16 or Intra 4×4. Intra 16×16 is used for areas that are relatively uniform and Intra 4×4 is used for areas that are non-uniform and have more detail. In the present embodiment, inputs to this classification are the means of the 16 4×4 sub-blocks of a MB and the variance of these means. Intuitively, the variance would be small for Intra 16×16 and large for Intra 4×4 coded MBs. The Intra MB mode is determined without evaluating any prediction modes. This method right away eliminates the evaluation of the prediction modes of the MB mode that is not selected. The sub-block mean computation takes 256 simple operations (240 additions and 16 shifts) and variance computation takes 32 additions and 16 multiplications—a total of 304 operations.

### Intra 16×16 Prediction Mode Decision (Nodes 1,3)

In the present embodiment, when the Intra 16×16 MB decision is made, the next step is to determine the prediction modes. Prediction modes 0, 1, and 2 are supported in this example. The Intra 16×16 prediction modes in H.264 depend on the edge pixel values in the neighboring MBs. The prediction direction is determined based on how close the mean of the current MB (μ_{C}) pixels are to the mean of the bottom row of the above MB (μ_{BR}) and right column of the MB to the left (μ_{RC}). The decision tree is thus made using relative means: |μ_{C}−μ_{BR}|, |μ_{C}−μ_{RC}| and |μ_{C}−(μ_{BR}+μ_{RC})/2|. The decision tree first uses a binary decision to classify DC vs. non-DC modes (node 1) and then uses a separate tree (node 3) for classifying non-DC modes into horizontal and vertical predictions. The computation required are 16 operation to compute the mean of the mean of the current MB using the means of the 4×4 sub-blocks computed in the first step, 33 operation to calculate the relative means—a total of 50 simple operations (add/subtract/shift/absolute).

### Intra 4×4 Prediction Mode Decision (Nodes 2, 4, 5, 6)

In the present embodiment, for Intra 4×4 MBs, the next step is to determine the prediction direction for the sub-blocks. Prediction modes 0-4 are supported. Similar to Intra 16×16 prediction modes, the Intra 4×4 prediction modes depend on the pixel values on the neighboring 4×4 sub-blocks. The classification is done using: |μ_{C}−μ_{BR}|, |μ_{C}−μ_{RC}|, and |μ_{BR}−μ_{RC}| where the mean values refer to the 4×4 sub-block, top-row of the sub-block, and the right-column of the sub-block. Node 2 performs a DC vs. non-DC mode classification, node 4 performs diagonal vs. non-diagonal classification, and nodes 5 and 6 further classify modes 0,1 and 3,4 respectively. The computations required per sub-block are 8 simple operations for the mean of neighboring pixels and three absolute value computations—a total of 11 operations. For a Intra 4×4 MB in the present embodiment, there are 16 sub-blocks that require a total of 176 simple operations.

### Performance Evaluation For The Example

A 4×4 sub-block requires 322 operations to evaluate all the five prediction modes, modes 0-4, which are used in the example of this embodiment. This is a total of 5152 operations for the 16 sub-blocks of the MB (luma component). For Intra 16×16 prediction modes, evaluating the prediction modes 0, 1, and 2 requires 874 operations per MB. Using the reference implementation such as JM10.2 requires 6026 operations per MB. With the approach of the present embodiment, the Intra 16×16 mode requires 304 operations for MB mode computations and 50 operations for prediction mode computations—a total of 354 operations per MB. For Intra 4×4 MB, the present example requires 304 operations for MB mode computations and 176 operations for prediction mode computations—a total of 480 operations. With the approach of the present embodiment, Intra 16×16 MB mode computation is 17 times faster than the standard and for Intra 4×4 MBs this is 12.5 times faster. The decision trees are if-else statements that are computationally inexpensive to implement.

Inter MB coding is the most compute intensive component of video encoding. The Inter MB are coded using motion compensation, i.e, a prediction of the current block is located in the previous frames and the difference between the prediction and the original is encoded. This process is referred to as motion compensation and the complexity increases with number of available block sizes and coding options. The described machine learning approach can be applied to Inter MB coding as well.

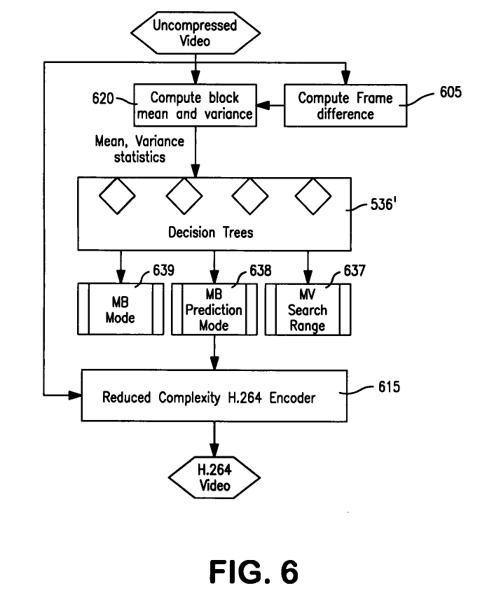

The process for Inter MB coding in depicted in FIGS. 5 and 6. Since the inter coding depends on the similarities between the current frame with the previous frame, a frame difference (block 505) can be used to characterize this similarity. In the learning/configuring stage of FIG. 5, the blocks 510, 520, 530, 531, and 536 correspond generally to functions of like reference numerals (i.e., the last two digits) in FIG. 2. In this case, however, motion vector data, Intra prediction modes, etc. are output from the H.264 encoder for use in the machine learning process. The amount of detail in a MB can be characterized using mean and variance of the sub-blocks and this can be used to select the MB partitioning for the Inter MB. A inter MB can be coded as Inter 16×16, two 16×8, two 8×16, or four 8×8 blocks. Each 8×8 block can be coded as 8×8, two 8×4, two 4×8, or four 4×4. Searching for the best mode among these possible options is highly complex. As before, the machine learning based classification reduces the complexity by computing the mode instead of searching for it.

In the operating/encoding stage of FIG. 6, the configured decision trees are represented at 536′ and the reduced complexity encoder, which utilizes the mode information from the decision trees (including motion vector search range (block 637), macroblock prediction mode (block 638), and macroblock mode (block 639)), instead of the conventionally computed modes. The blocks 605 and 620 respectively represent computation of the frame difference and the block mean and variance statistics.

1. A method for encoding frames of input video signals, comprising the steps of:
implementing a learning/configuring stage that includes the following steps:
providing frames of training video signals;
determining training statistical parameters for groups of pixels of said frames of training video signals, and also encoding said frames of training video signals to obtain training modes;
configuring a decision tree in response to said training statistical parameters and said training modes; and
implementing an operating/encoding stage that includes the following steps:
determining operating statistical parameters for groups of pixels of said frames of input video signals, and applying said operating statistical parameters to said configured decision tree to obtain operating modes; and
encoding said frames of input video signals using said frames of input video signals and said operating modes.

2. The method as defined by claim 1, wherein said step of configuring a decision tree in response to said training statistical parameters and said training modes comprises performing a machine learning routine to configure said decision tree to implement mode selections as a function of statistical parameters, based on observed correlations between said training statistical parameters and said training modes.

3. The method as defined by claim 1, wherein said training modes and operating modes include macroblock modes and predictive modes.

4. The method as defined by claim 1, wherein said statistical parameters for groups of pixels of frames of training video signals and input video signals include means of blocks of pixels and variance of said means.

5. The method as defined by claim 1, wherein said statistical parameters for groups of pixels from frames of training video signals and input video signals are derived from blocks of pixels of individual frames.

6. The method as defined by claim 1, wherein said statistical parameters for groups of pixels from frames of training video signals and input video signals are derived from blocks of pixels of successive frames.

7. The method as defined by claim 1, wherein said statistical parameters for groups of pixels from frames of training video signals and input video signals are derived from differences of blocks of pixels of individual frames.

8. The method as defined by claim 6, wherein said statistical parameters for groups of pixels of frames of training video signals and input video signals include means and variance statistics.

9. The method as defined by claim 1, wherein said training modes and operating modes include macroblock prediction modes and motion vector data.

10. The method as defined by claim 6, wherein said training modes and operating modes include macroblock prediction modes and motion vector data.

11. The method as defined by claim 10, wherein said step of configuring a decision tree in response to said training statistical parameters and said training modes comprises performing a machine learning routine to configure said decision tree to implement mode selections as a function of statistical parameters, based on observed correlations between said training statistical parameters and said training modes.

12. The method as define by claim 1, wherein said step of encoding said frames of input video signals using said frames of input video signals and said operating modes comprises encoding said frames of input video signals using said operating modes instead of corresponding modes that are not computed from said frames of input video signals.

13. The method as define by claim 2, wherein said step of encoding said frames of input video signals using said frames of input video signals and said operating modes comprises encoding said frames of input video signals using said operating modes instead of corresponding modes that are not computed from said frames of input video signals.

14. The method as define by claim 11, wherein said step of encoding said frames of input video signals using said frames of input video signals and said operating modes comprises encoding said frames of input video signals using said operating modes instead of corresponding modes that are not computed from said frames of input video signals.

15. The method as defined by claim 1, wherein said steps of encoding said frames of training video signals comprise encoding using an MPEG encoding standard.

16. The method as defined by claim 15, wherein said MPEG encoding standard is H.264.

17. The method as defined by claim 1, further comprising decoding the encoded frames of input video signal.

18. The method as defined by claim 17, further comprising transmitting the encoded signal before decoding thereof.

19. The method as defined by claim 1, wherein the steps of said learning/configuring stage and the steps of said operating/encoding stage are performed using at least one processor.

20. A method for encoding a video signal, comprising the steps of:
separating frames of video into a multiplicity of macroblocks;
computing, for each macroblock, at least one statistical parameter;
selecting, for each of said macroblocks, a sub-block coding criterion based on the computed at least one statistical parameter of the respective macroblock;
implementing the selected coding criterion on sub-blocks of each respective macroblock to obtain encoded macroblocks; and
producing an encoded video signal using the encoded macroblocks.

21. The method as defined by claim 20, wherein said statistical parameter is indicative of detail in a macroblock.

22. The method as defined by claim 20, wherein said step of computing, for each macroblock, at least one statistical parameter, comprises computing, for each macroblock, a variance of values in the macroblock.

23. The method as defined by claim 22, wherein said values comprise means of the pixel values in groups of pixels in the macroblock.

24. The method as defined by claim 22, wherein said values comprise transforms relating to pixel values for groups of pixels in the macroblock.

25. The method as defined by claim 20, wherein said step of computing, for each macroblock, at least one statistical parameter, comprises computing, for each macroblock, a variance of means of pixel values in equal sized groups of pixels in the macroblock.

26. The method as defined by claim 20, wherein said step of selecting, for each macroblock, a sub-block coding criterion, includes selecting a sub-block size and/or geometry.

27. The method as defined by claim 20, wherein said recited steps are performed by at least one processor.

28. A method for encoding and decoding a video signal, comprising the steps of:
separating frames of video into a multiplicity of macroblocks;
computing, for each macroblock, at least one statistical parameter;
selecting, for each of said macroblocks, a sub-block coding criterion based on the computed at least one statistical parameter of the respective macroblock;
implementing the selected coding criterion on sub-blocks of each respective macroblock to obtain encoded macroblocks;
producing an encoded video signal using the encoded macroblocks; and
decoding the encoded signal to recover a decoded video signal.

29. The method as defined by claim 28, further comprising transmitting the encoded signal before the decoding thereof.
